(19) United States
(12) Patent Application Publication
(10) Pub. No.: US 2018/0060409 A1
(43) Pub. Date: Mar. 1, 2018

(54) MULTI-DIMENSIONAL MATCH ENGINE

(71) Applicant: SAP SE, Walldorf (DE)

(72) Inventors: Dipesh Bhattacharya, Fremont, CA (US); Sharosh Rajasekher, Herndon, VA (US); Jiandong Shi, Pleasanton, CA (US); Keqin Liu, Pleasanton, CA (US); Li Wei Xu, Shanghai (CN); Kejun Zhu, Shanghai (CN); Biao Hao, Shanghai (CN); Xiaoxin Wu, Shanghai (CN); Taihong Wu, Shanghai (CN); Jiaojiao Wang, Shanghai (CN); Xiao Gao, Shanghai (CN)

(21) Appl. No.: 15/379,272

(22) Filed: Dec. 14, 2016

Related U.S. Application Data
(60) Provisional application No. 62/379,963, filed on Aug. 26, 2016.

(51) Int. Cl. G06F 17/30

(52) U.S. Cl. CPC G06F 17/30592; G06F 17/30554; G06F 17/30324; G06F 17/30333

(57) ABSTRACT

A method may include: generating, by a controller, a first user interface configured to control selection of a first attribute from a set of attributes; generating, by the controller, a second user interface generated based on the controlled selection of the first attribute, the second user interface configured to enable selection of values with respect to the first attribute; generating, by the controller, a first query to enable querying at the database based on the one or more values with respect to the first attribute; generating, by the controller, a second query for execution at the database, when the first query fails to respond with a match, the second query including a first vector representative of a profile to enable querying the database; and generating, in response to the first query and/or the second query, a third user interface indicative of a result.

### CROSS REFERENCE TO RELATED APPLICATION

This application claims priority under 35 U.S.C. § 119(e) to U.S. Provisional Patent Application No. 62/379,963 file on Aug. 26, 2016 and entitled MULTI-DIMENSIONAL MATCH ENGINE, the disclosure of which is incorporated herein by reference in its entirety.

### TECHNICAL FIELD

The subject matter described herein relates generally to a controller configured to conduct vector-based matching.

### SUMMARY

Systems, methods, and articles of manufacture, including computer program products, are provided for a multi-dimensional controller. In one aspect, there is provided a method. The method may include: generating, by a controller, a first user interface configured to control selection of a first attribute from a set of attributes; generating, by the controller, a second user interface generated based on the controlled selection of the first attribute, the second user interface configured to enable a selection of one or more values with respect to the first attribute; generating, by the controller, a first query to enable querying at the database based on the one or more values with respect to the first attribute; generating, by the controller, a second query for execution at the database, when the first query fails to receive a response with a match, the second query including a first vector representative of a profile to enable querying the database; and generating, in response to the first query and/or the second query, a third user interface indicative of a result.

In some variations, one or more features disclosed herein including the following features can optionally be included in any feasible combination. The profile may include a plurality of attributes associated with a first user, and the first vector may include a numerical representation of at least a portion of the plurality of attributes associated with the first user. The second query may be executed at the database by at least: computing a dot product between the first vector and a second vector representative of a reference profile at the database; and matching the profile to the reference profile, when the dot product exceeds a threshold value

In some variations, the second query may be executed at the database by at least: computing a dot product between the first vector and a second vector representative of a first reference profile at the database; computing another dot product between the first vector and a third vector representative of a second reference profile at the database; and matching the profile to the first reference profile, when the dot product associated with the first reference profile exceeds the other dot product associated with the second reference profile.

In some variations, the result may include the profile being matched to one or more reference profiles at the database.

In some variations, the second query may include a hash value corresponding to the first vector. The second query may be executed at the database by at least: matching a first reference profile to the profile, when the hash value corresponding to the first vector is the same as a hash value corresponding to a second vector representative of the first reference profile. The hash value of the second vector may be stored, at the database, in a sorted list of hash values that includes the hash value of the second vector and a hash value of a third vector representative of a second reference profile, and the executing of the second query may include a lookup of the sorted list hash values.

In some variations, the first user interface may be generated for presentation at a first device associated with a first user, and the second user interface and/or the third user interface may be generated for presentation at a second user device associated with a second user. The first user interface may be configured to enable the first user to specify one or more input types and/or input values that the second user is able to input, via the second user interface, with respect to the first attribute.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to web application user interfaces, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a block diagram illustrating a system, in accordance with some example embodiments;

FIG. 1B depicts a vector, in accordance with some example embodiments;

FIG. 2 depicts a block diagram illustrating a controller, in accordance with some example embodiments;

FIG. 3A depicts a user interface, in accordance with some example embodiments;

FIG. 3B depicts a user interface, in accordance with some example embodiments;

FIG. 3C depicts a user interface, in accordance with some example embodiments;

FIG. 3D depicts a user interface, in accordance with some example embodiments;

FIG. 4A depicts a user interface, in accordance with some example embodiments;

FIG. 4B depicts a user interface, in accordance with some example embodiments;

FIG. 4C depicts a user interface, in accordance with some example embodiments;

FIG. 5 depicts a flowchart illustrating a process for generating a mentoring program, in accordance with some example embodiments;

FIG. 6A depicts a flowchart illustrating a process for matching a group of mentees to mentors, in accordance with some example embodiments;

FIG. 6B depicts a flowchart illustrating a process for matching a group of mentees and mentors; and

FIG. 7 depicts a block diagram illustrating a computing system, in accordance with some example embodiments.

When practical, similar reference numbers denote similar structures, features, or elements.

### DETAILED DESCRIPTION

In some implementations, a controller may be configured to generate one or more user interfaces for presentation at different user devices. For example, the controller may generate, for presentation at a first user device, a first user interface that is configured to enable a selection of one or more attributes from a set of attributes. According to some implementations, the controller may further generate, for presentation at a second user device, a second user interface that is configured to enable an input with respect to the one or more attributes selected via the first user interface. That is, the controller may generate a second user interface that limits, based on the selections made via the first user interface, the attributes that are displayed on the second user interface. The controller may generate a first query based on the inputs with respect to one or more attributes. For instance, the controller may generate a structured query language (SQL) statement that queries a database for records matching the inputs with respect to the one or more attributes.

In some implementations, when the first query fails to return any records that match the input with respect to the one or more attributes, the controller may generate a second query that includes a vector representation of a profile. The vector representation of the profile may include a numerical representation of at least a portion of the attributes included in the profile. The second query may be executed at a database by at least matching the vector representation of the profile to the respective vector representations of one or more profiles stored at the database. According to some implementations, the controller may generate the second query by generating a hash value corresponding to the profile. For example, the controller may generate the hash value by at least applying a hash function to the vector representation of the profile (e.g., the numerical representation of the attributes that are included in the profile). Thus, the second query may include the hash value of the profile and the executing of the second query may include matching the hash value of the profile to the respective hash values of the one or more profiles stored at the database. Because the hash value of the profile may be identical and/or similar to the hash value of profiles that include the same and/or similar attributes, performing a hash value based match may expedite the execution of the second query.

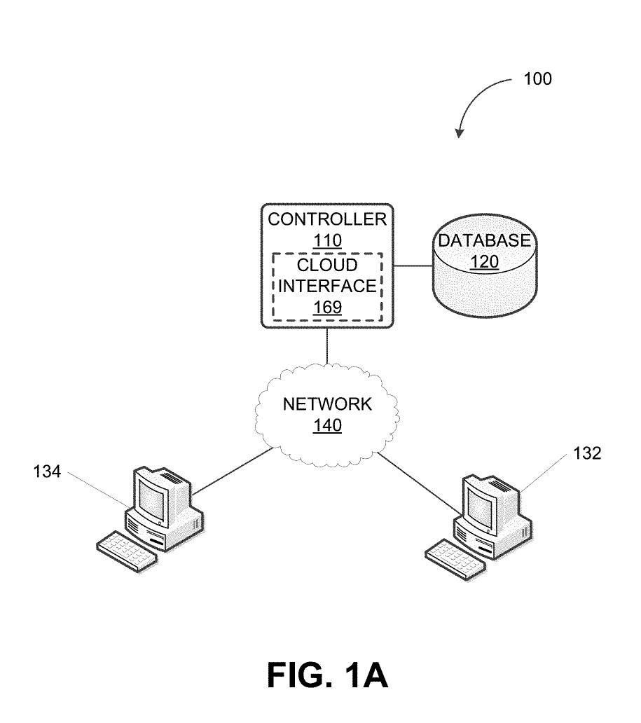

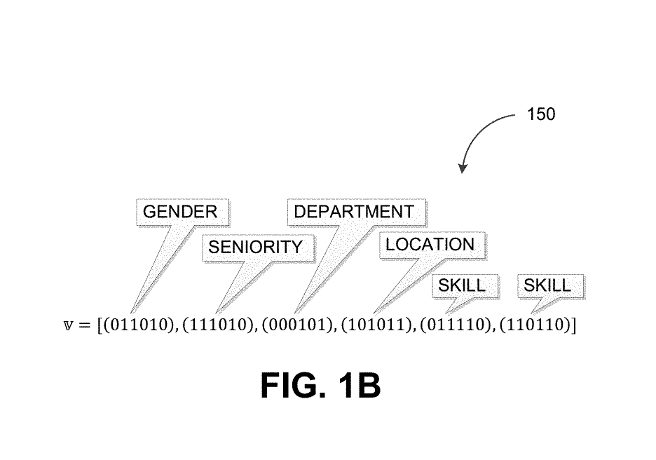

FIG. 1A depicts a block diagram illustrating a system 100, in accordance with some example embodiments.

The system 100 may include one or more user devices 132-134, such as a cell phone, smart phone, tablet, and/or any other type of processor and memory based device. The user devices 132-134 may couple to a controller 110 via a network 140, such as the Internet and/or any other type of link or network. The controller 110 may be configured to automatically match attributes. Furthermore, the controller 110 may be communicatively coupled to a database 120, such as a database management system including an in-memory database, relational database, and/or other types of persistence. The database 120 may include a plurality of attribute data including profiles, such as mentor and/or mentee profiles, that may include data corresponding to a plurality of individual attributes including, for example, gender, department, division, location, job level, job family, job role, job code, and job title.

In some implementations, the controller 110 may be implemented as a service, such as a cloud-based software-as-a-service (SaaS), and may be accessed via a cloud interface 169. In the case of a cloud-based implementation of the controller, a server may provide the SaaS to user devices coupling via the network 140.

In some implementations, a plurality of controllers may be instantiated for a plurality of clients. For example, a first entity, such as company X, including one or more user devices may access the cloud interface 169 and then be directed to a controller and data store, while a second entity, such as company Y, including one or more user devices may access the cloud interface 169 and then be directed to another controller and another data store. In this example, cloud interface 169 may couple to, or include a hypervisor to instantiate a virtual machine hosting each of the controllers and/or data store. The virtual machines may provide a sandbox providing privacy to the data being handled for each entity.

The controller 110 may, as noted, be configured to identify matches in data. For example, the controller may find matches as part of an enterprise planning system, such as a human resources management system. For example, the controller may find matches for a mentoring program through one or more customizable user interfaces. For example, the first user device 132 may be associated with an administrator responsible for creating and/or conducting a mentoring program at the enterprise. As such, the controller 110 may receive, from the first user device 132, inputs for generating a mentoring program including, for example, a program description and control dates during which the mentoring program should run. The controller 110 may further receive, from the first user device 132, a first group of individuals who are designated as potential mentors and a second group of individuals who are designated as potential mentees.

In some example embodiments, the controller 110 may generate and/or provide a user interface that may be used by an administrator (e.g., a user of the first user device 132) to customize one or more aspects of the mentoring program. For instance, the user interface may be a graphic user interface providing one or more visual elements (e.g., text boxes, dropdown menus, buttons, radio buttons) that may be used for entering data relevant to the mentoring program including, for example, the program description, control dates, mentor and/or mentee designations, and sign-up form and/or invitation customizations. According to some example embodiments, the controller 110 may provide at least a first user interface that may be used by an administrator (e.g., a user of the first user device 132) to generate a second user interface, which may be used by participants in the mentoring program (e.g., mentors and/or mentees). For example, the controller 110 may receive, via the first user interface, inputs from the administrator for generating the second user interface including, for example, a selection of mentor attributes. A mentor attribute may be a feature and/or characteristic that is present in a mentor including, for example, a location, department, division, gender, skills, and seniority of the mentor. The controller 110 may further generate the second user interface based on the inputs received from the administrator and may provide the second user interface to various participants of the mentoring program. For instance, the controller 110 may be configured to provide the second user interface (e.g., to a user of the second user device 134) at certain points during the mentoring program including, for example, at sign-up and/or registration.

The controller 110 may be configured to identify matches between at least a first group of individuals and a second group of individuals. For example, the controller 110 may be configured to identify matches between a group of mentors and a group of mentees. The controller 110 may be configured to identify matches based on a plurality of dimensions. For example, the controller 110 may identify matches based on specific mentor selections, preferred mentor attributes, and/or correlations between the respective profiles of mentors and mentees. In some example embodiments, the controller 110 may first attempt to identify a mentor for each mentee based on one or more mentees' specific mentor selections. If a matching mentor is not found for every mentee, the controller 110 may subsequently attempt to match mentors to mentees based on the preferred mentor attributes specified by each mentee. Mentees who are still not matched to any mentors may then be matched based on the respective profiles of the mentor and mentees. The database 120 may be configured to store at least some mentor and/or mentee profiles. Thus, the controller 110 may be configured to retrieve one or more mentor and/or mentee profiles from the database 120.

In some example embodiments, the controller 110 may generate a first query to identify matching mentors based on the preferred mentor attributes specified by mentee. The first query may be executed at the database 120 by at least locating records of mentors having the preferred mentor attributes specified by the mentee. However, when executing the first query fails to locate any records of mentors having the preferred mentor attributes specified by the mentee, the controller 110 may generate a second query configured to identify matching mentors based on the respective profiles of the mentee and a plurality of mentors. According to some implementations, generating the second query may include generating a vector representation of the mentee's profile. For example, the mentee's profile may include one or more attributes specific to the mentee including, for example, the mentee's gender, department, division, location, job level, job family, job role, job code, job title, and/or skills. The vector representation of the mentee's profile may include a numerical representation (e.g., bit strings and/or the like) of at least a portion of the attributes that are included in the mentee's profile. The second query may be executed at the database 120 by identifying, based at least on the respective vector representations of the mentee's profile and a plurality of mentor profiles stored at the database 120, mentors having the same and/or similar profiles as the mentee. For instance, the controller 110 may determine whether a mentor has the same and/or similar profile (e.g., with the same and/or similar attributes) as the mentee by at least computing a dot product between the vector representation of the mentee's profile and the vector representation of the mentor's profile. The closer the value of the dot product is to one, the greater the similarity between the mentor and the mentee's profile and the more compatible the match is between the mentor and the mentee.

FIG. 1B depicts a vector 150, in accordance with some example embodiments. Referring to FIG. 1B, the vector 150 may be the vector representation of a mentee's or a mentor's profile. The vector 150 may include numerical representations of a plurality of attributes that may be included in a mentee's or a mentor's profile. As shown in FIG. 1B, the vector 150 may include binary strings corresponding to a mentor or a mentee's gender, seniority, department, location, and one or more skills. Although the vector 150 is shown to include a plurality of binary strings, it should be appreciated that the vector 150 can include different numerical representations of the attributes (e.g., hexadecimal strings). As noted earlier, the controller 110 may determine whether a mentor has the same and/or similar profile as a mentee by at least computing a dot product between two vectors, such as the vector 150, that are representative of the respective profiles of the mentor and the mentee. In some implementations, the mentor may be identified as a matching mentor when the dot product exceeds a threshold value. Alternately and/or additionally, the controller 110 may compute a dot product for every available mentor and select, as matching mentors, those mentors having the highest dot product.

In some implementations, to identify matching mentors and mentees, the controller 110 may generate a hash value corresponding to the mentee's profile. For example, the controller 110 may generate the hash value by at least applying a hash function to a vector (e.g., the vector 150) representative of the mentee's profile (e.g., the numerical representation of the attributes included in the mentee's profile). As such, the second query may include the hash value of the mentee's profile and executing the second query (e.g., at the database 120) may include locating records of mentors whose profiles have the same and/or similar hash values. It should be appreciated that the hash value of two same and/or similar profiles may also be the same and/or similar. Thus, to expedite the execution of the second query at the database 120, the database 120 may store a sorted list of the hash values corresponding to a plurality of mentor profiles. Identifying one or more mentors that are compatible with a mentee may include a fast lookup of one or more hash values in the sorted list of hash values that are the same and/or similar to the hash value corresponding to the mentee's profile.

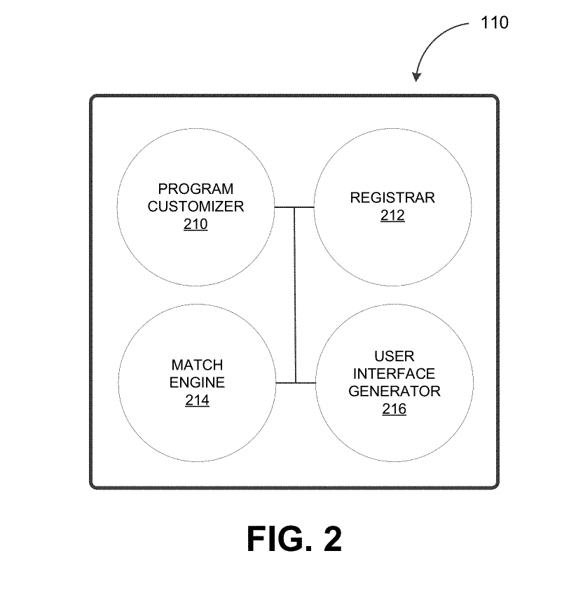

FIG. 2 depicts a block diagram illustrating the controller 110, in accordance with some example embodiments. Referring to FIGS. 1-2, the controller 110 may include a program customizer 210, a registrar 212, a match engine 214, and a user interface generator 216.

In some example embodiments, the program customizer 210 may be configured to generate a customized mentoring program. For example, the program customizer 210 may receive, from an administrator of a mentoring program (e.g., the user of the first user device 132), inputs for customizing the mentoring program including, for example, a program description and control dates (e.g., start and end dates for the mentoring program). The customization module 210 may further receive personal identifiers (e.g., names, employee identification numbers) for designating various individuals as potential mentors and/or mentees. For instance, the program customizer 210 may receive, from the administrator of the mentoring program, a designation of the user of the second user device 134 as a mentor and/or a mentee. Designating the user of the second user device 134 as a mentor and/or a mentee may cause an invitation to be sent to that user (e.g., via electronic mail). The invitation may provide information for how the user of the second user device 134 may sign up and/or register (e.g., as a mentor and/or mentee) for the mentoring program.

In some example embodiments, the registrar 212 may be configured to receive inputs from various participants of a mentoring program. For instance, individuals who have been designated (e.g., via the program customizer 210) as mentors and/or mentees for the mentoring program may receive invitations with information on how to sign up and/or register for the mentoring program. As such, the registrar 212 may receive, from these individuals (e.g., in response to the invitations), inputs that include information required to sign up and/or register for the mentoring program. For example, an individual designated as a mentee (e.g., the user of the second user device 134) may provide, to the registration module 210, an indication of one or more specific mentors that the mentee would prefer to be matched with. Alternately and/or additionally, the individual may provide, to the registration module 210, a specification of one or more attributes (e.g., location, department and/or division, gender, skills, seniority) for mentors that the mentee would prefer to be matched with. However, it should be appreciated that an individual designated as a mentee may not, in some instances, provide any specification of specific mentors and/or attributes that should be present in the mentor that the mentee would prefer to be matched with. According to some example embodiments, the registrar 212 may sign up and/or register a participant (e.g., mentor and/or mentee) by at least storing, in the database 120, information associated with that participant (e.g., specific mentor selection, preferred mentor attributes).

In some example embodiments, the match engine 214 may be configured to identify matches between individuals designated as mentors and individuals designated as mentees. This identification of compatible mentors and mentees may be based on a plurality of dimensions including, for example, specific mentor selections, preferred mentor attributes, and/or correlations between the profiles of mentors and mentees. According to some example embodiments, the match engine 214 may be configured to identify compatible mentors and mentees by at least applying the plurality of dimensions in progression. For example, the match engine 214 may first attempt to identify compatible mentor and mentees based on each mentee's specific mentor selection. For mentees that cannot be matched to at least one mentor based on each mentee's specific mentor selections, the match engine 214 may subsequently identify compatible mentors for these mentees based on preferred mentor attributes (e.g., location, department, division, gender, skills, seniority), as specified by the mentees (e.g., during sign-up and/or registration via the registrar 212). Any remaining mentees can then be matched to a mentor based on the respective profiles (e.g., employee profiles) of the mentors and mentees. Here, the match engine 214 may retrieve, from the database 120, one or more profiles. For example, the match engine 214 may retrieve, via one or more structure query language (SQL) statements and/or application programming interface (API) calls, the profiles of various mentors and mentees (e.g., stored in the database 120). By applying the plurality of dimensions in progression, the match engine 214 may be able to match every mentee to at least one mentor. However, it should be appreciated that the match engine 214 may, in some instance, be unable to match every mentee to at least one mentor. In this scenario, an administrator of the mentoring program may perform a manual or supervised match.

In some example embodiments, the match engine 214 may generate a first query to identify matching mentors based on the preferred mentor attributes specified by mentee. The first query may be executed (e.g., at the database 120) by at least locating records of mentors having the preferred mentor attributes specified by the mentee. However, when executing the first query fails to locate any records of mentors having the preferred mentor attributes specified by the mentee, the match engine 214 may generate a second query configured to identify matching mentors based on the respective profiles of the mentee and a plurality of mentors.

According to some implementations, the second query may include a vector representation of the mentee's profile. The vector representation of the mentee's profile may include a numerical representation (e.g., bit strings and/or the like) of at least a portion of the attributes that are included in the mentee's profile. The second query may be executed at the database 120 by identifying, based at least on the respective vector representations of the mentee's profile and a plurality of mentor profiles stored at the database 120, mentors having the same and/or similar profiles as the mentee. For instance, the match engine 214 may determine whether a mentor has the same and/or similar profile (e.g., with the same and/or similar attributes) as the mentee by at least computing a dot product between the vector representation of the mentee's profile and the vector representation of the mentor's profile. The match engine 124 may identify the mentor as a matching mentor for the mentee when the dot product exceeds a threshold value. Alternately and/or additionally, the match engine 214 may compute a dot product for every available mentor and select, as matching mentors, those mentors associated with the highest dot product.

Alternately and/or additionally, the match engine 214 may generate a hash value corresponding to the mentee's profile when generating the second query. For example, the controller 110 may generate the hash value by at least applying a hash function to the vector representation (e.g., the vector 150) of the mentee's profile. In doing so, the match engine 214 may generate the second query to include the hash value of the mentee's profile. Furthermore, executing the second query (e.g., at the database 120) may include locating records of mentors whose profiles have the same and/or similar hash values. For instance, identifying one or more mentors that are compatible with a mentee may include a fast lookup (e.g., at the database 120), based on the hash value of the mentee's profile, of mentor profiles having the same and/or similar hash value.

In some example embodiments, the match engine 214 may be configured to generate a match metric for one or more matches between mentors and mentees. That is, for a match between a mentor and a mentee, the match engine 214 may determine a match metric corresponding to the dimension used to generate the match. For example, the match engine 214 may determine that the match metric for a match between a mentor and a mentee is “preferred” or “excellent” if this pair of mentor and mentee were matched based on the mentee's specific mentor selection (e.g., the mentee indicated a preference to be matched to this specific mentor). Alternately and/or additionally, the match engine 214 may determine that the match between the mentor and mentee is “good” if the mentor was matched to the mentee based on the mentee's preferred mentor attributes (e.g., the mentor exhibits one or more of the preferred mentor attributes specified by the mentee). The match engine 214 may determine that the match between the mentor and mentee is “average” if the mentor and mentee were matched based on the respective profiles (e.g., employee profiles) of the mentor and mentee. The match metric may be generated based on different and/or additional criteria.

In some example embodiments, the user interface generator 216 may be configured to provide, to the first user device 132 and/or the second user device 134, one or more user interfaces (e.g., graphic user interfaces (GUIs)). For instance, the user interface generator 216 may provide user interfaces adapted to receive, from the administrator of the mentoring program (e.g., the user of the first user device 132), input for customizing the mentoring program including, for example, a program description, control dates, and designation of program participants (e.g., mentors and mentees). Alternately and/or additionally, the user interface generator 216 may provide a first user interface and a second user interface. The first user interface may be adapted to receive, from the administrator of the mentoring program, inputs for generated the second user interface. Meanwhile, the second user interface may be adapted to receive inputs from participants of the mentoring program (e.g., mentors and/or mentees).

According to some example embodiments, a customized mentoring program may be associated with one or more user interfaces. Thus, the administrator of a mentoring program may provide, to the user interface generator 216, inputs for generating the second user interface for use during sign-up and/or registration. For instance, the administrator of the mentoring program may be able to establish the preferred mentor attributes that mentees are able to stipulate during the sign-up and/or registration phase of the mentoring program. Accordingly, the second user interface may display a selection of preferred mentor attributes, as specified by the administrator of the mentoring program specifies via the first user interface. The user interface generator 216 may provide, to mentees participating in the mentoring program (e.g., the user of the second user device 134), the second user interface. A mentee may indicate, via the second user interface, one or more preferred mentor attributes (e.g., location, department and/or division, gender, skills, seniority) that may be used to identify compatible mentors for that mentee.

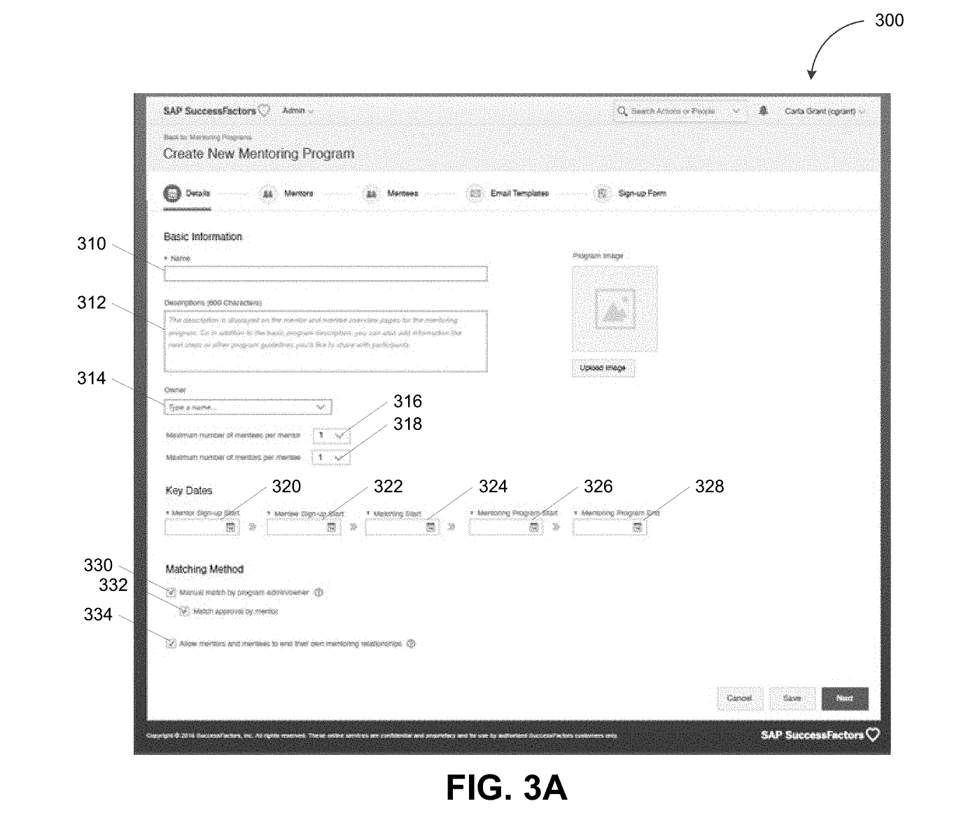

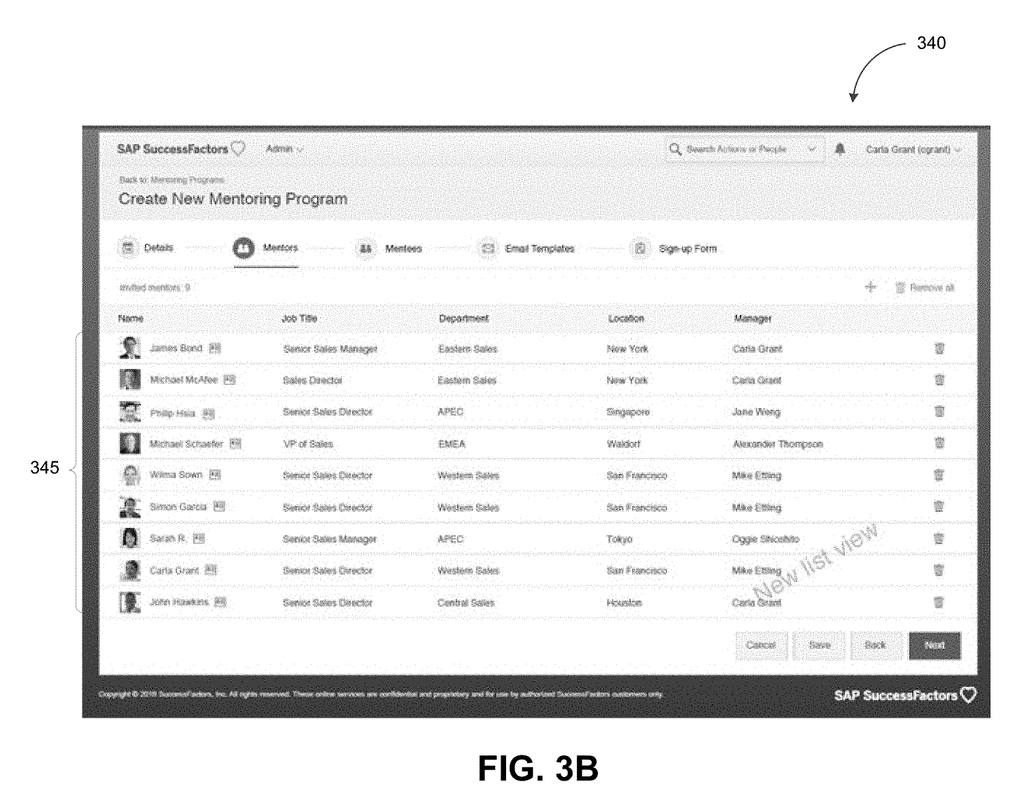

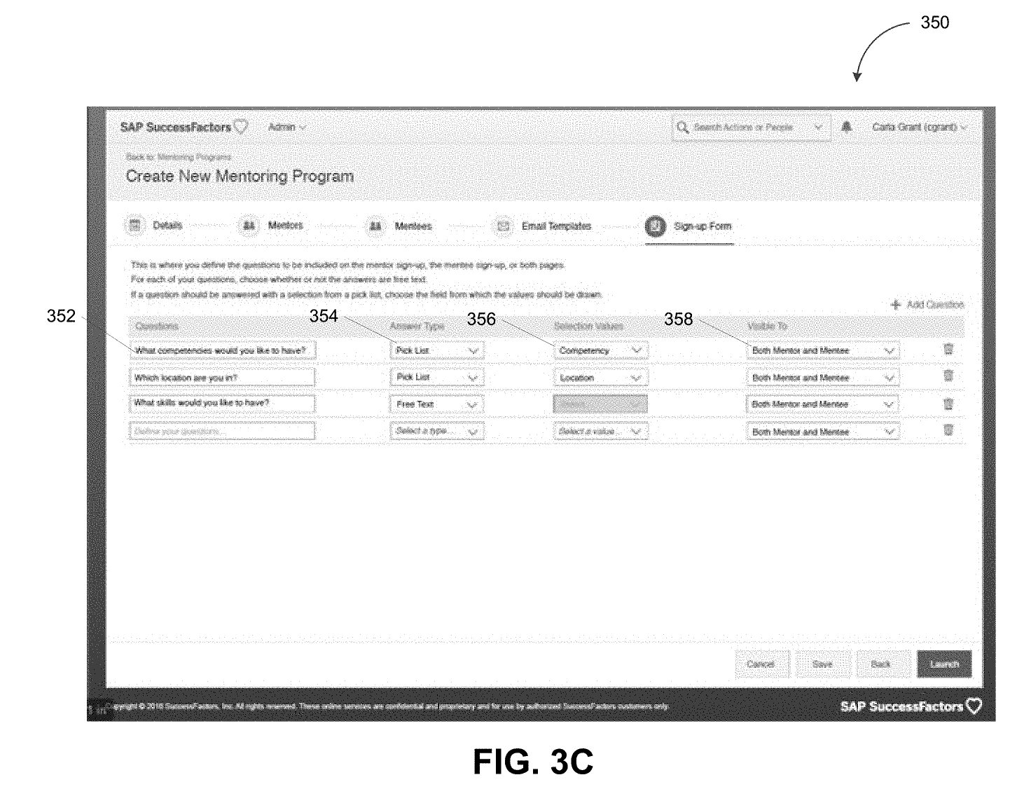

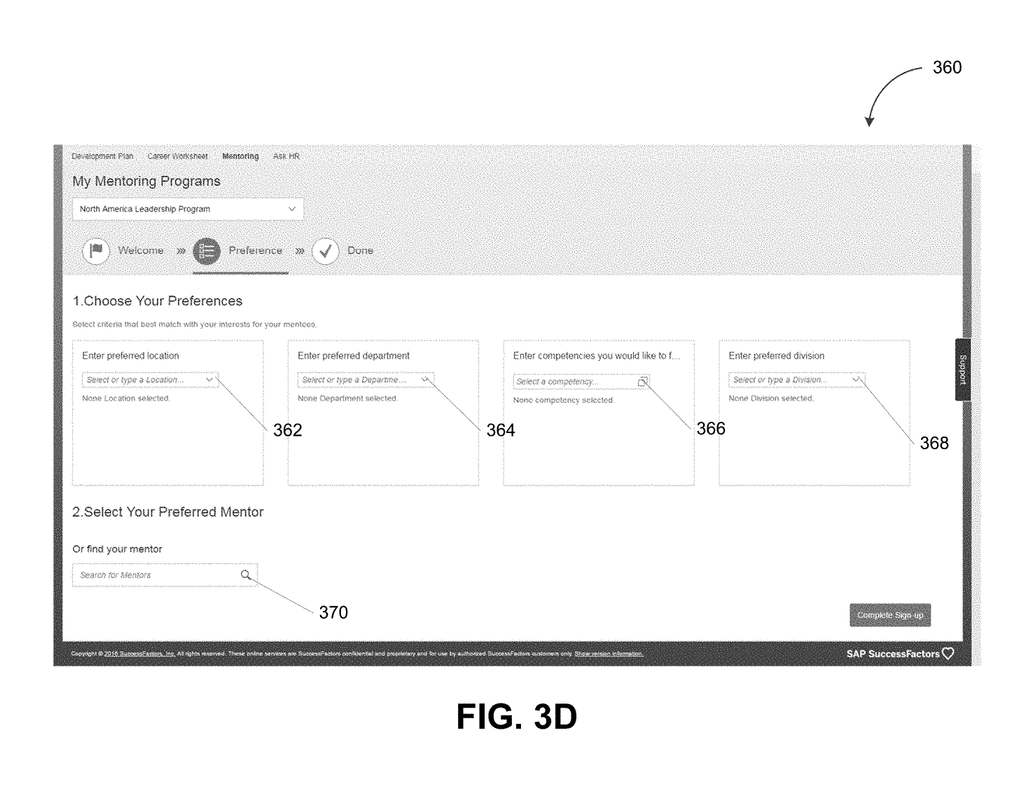

FIG. 3A depicts a user interface 300, in accordance with some example embodiments. Referring to FIGS. 1-2 and 3A, the controller 110 (e.g., the user interface generator 216) may provide the user interface 300 to an administrator of the mentoring program. The user interface 300 may be configured to receive, from the administrator of the mentoring program, one or more inputs for creating and/or configuring a mentoring program.

In some example embodiments, the user interface 300 may include a plurality of text boxes including, for example, a first text box 310, a second text box 312, and a third text box 314. The user interface 300 may further include a plurality of dropdown menus including, for example, a first dropdown menu 316, a second dropdown menu 318, a third dropdown menu 320, a fourth dropdown menu 322, a fifth dropdown menu 324, a sixth dropdown menu 326, and a seventh dropdown menu 328.

As shown in FIG. 3A, the first text box 310 may be used to input a name for the mentoring program, the second text box 312 may be used to input a description for the mentoring program, and the third text box 314 may be used to input a name of the individual who is responsible for the mentoring program (e.g., the administrator of the mentoring program). Meanwhile, the first dropdown box 316 and the second dropdown box 318 may be used to input respective limits on the number of mentees that can be matched to each individual mentor and the number of mentors that can be matched to each individual mentee. The third dropdown menu 320, the fourth dropdown menu 322, the fifth dropdown menu 324, the sixth dropdown menu 326, and the seventh dropdown menu 328 may be used to input key dates associated with the mentoring program including, for example, the start date for mentor and mentee sign-up and/or registration, the start date for matching mentors and mentees, and a start and end date for the mentoring program.

Referring again to the FIG. 3A, the user interface 300 may further include a first radio button 330, a second radio button 332, and a third radio button 334. The first radio button 330, the second radio button 332, and the third radio button 334 may be used to select one or more configurations for the mentoring program including, for example, the matching method that is used when matching mentors with mentees. For instance, as shown in FIG. 3A, the administrator of the mentoring program may select, via the first radio button 330, whether to enable manual or supervised matching (e.g., by the administrator of the mentoring program). The second radio button 332 may be used to specify whether matches between a mentor and mentee requires approval by the mentor. Meanwhile, the third radio button 334 may be used to specify whether mentors and mentees are able to terminate mentoring relationships.

FIG. 3B depicts a user interface 340, in accordance with some example embodiments. Referring to FIGS. 1-2 and 3B, the controller 110 (e.g., the user interface generator 216) may provide the user interface 340 to an administrator of the mentoring program. The user interface 340 may show a list 345 of individuals who have been designated as mentors by the administrator of the mentoring program. As shown in FIG. 340, each individual in the list 345 may be shown along with one or more mentor attributes associated with that individual including, for example, a job title, a department, a location, and manager.

FIG. 3C depicts a user interface 350, in accordance with some example embodiments. Referring to FIGS. 1-2 and 3C, the controller 110 (e.g., the user interface generator 216) may provide the user interface 350 to an administrator of the mentoring program. The administrator of the mentoring program may provide, via the user interface 350, one or more inputs for generating a user interface that can be used by a mentee participating in the mentoring program. As shown in FIG. 3C, the user interface 350 may include a plurality of visual elements useable by the administrator of the mentoring program to provide one or more inputs. For instance, the user interface 350 may include a text box 352, a first dropdown menu 354, a second dropdown menu 356, and a third dropdown menu 358.

In some example embodiments, the administrator of the mentoring program may provide, via the user interface 350, one or more inputs specifying which mentor attributes may be specified by the mentees participating in the mentoring program. For instance, the administrator of the mentoring program may allow a mentee to specify which competencies a mentor matched to that mentee should exhibit. As such, the administrator may input, via the text box 352, a question that may be posed to the mentee (e.g., “What competencies would you like to have?”) inquiring about a specific mentor attribute such as, for example, competency, location, skills, seniority, and/or the like. Based on the mentor attributes specified by the administrator via the user interface 350, one or more corresponding visual elements may be included in a user interface provided to the mentee such that the mentee is able to make a selection with respect to these mentor attributes. Moreover, the administrator may further input, via the first dropdown menu 354 and the second dropdown menu 356, the type of answer and the values (e.g., the available choices and/or options) a mentee can specify in responding to the question in text box 352. Accordingly, the user interface provided to the mentee may provide the same answer types and/or values specified by the administrator (e.g., via the first dropdown menu 352 and/or the second dropdown menu 354).

Alternately and/or additionally, the inputs provided via the user interface 350 may also be used to generate a user interface that can be used by a mentor participating in the mentoring program. In some example embodiments, a mentor can also specify preferences with respect to the attributes of mentees that the mentor is matched up with. For instance, a mentor can indicate a preference to be matched up with mentees in a particular location. Alternately and/or additionally, the mentor can indicate a preference to be matched up with mentees having and/or lacking certain competencies.

FIG. 3D depicts a user interface 360, in accordance with some example embodiments. Referring to FIGS. 1-2 and 3A-D, the controller 110 (e.g., the user interface generator 216) may provide the user interface 360 to a mentee participating in a mentoring program. Moreover, in some example embodiments, the user interface 360 may be generated based on inputs from an administrator of the mentoring program. For example, the administrator of the mentoring program may provide, via one or more other user interfaces (e.g., the user interface 350), inputs for generating the user interface 360.

As shown in FIG. 3D, the user interface 360 may be a graphic user interface providing a plurality of visual elements including, for example, a first dropdown menu 362, a second dropdown menu 364, a third dropdown menu 366, a fourth dropdown menu 368, and a text box 370. The user interface 360 may provide different and/or additional visual elements than shown (e.g., buttons, radio buttons).

Referring again to FIG. 3D, the user interface 360 may provide visual elements useable by a mentee (e.g., the user of the second user device 134) to sign up and/or register for a mentoring program. For instance, the mentee may use the first dropdown menu 362, the second dropdown menu 364, the third dropdown menu 366, and/or the fourth dropdown menu 368 to input one or more preferred mentor attributes. The first dropdown menu 362 may be used to input a preferred location for the mentor, the second dropdown menu 364 may be used to input a preferred department for the mentor, the third dropdown menu 366 may be used to input one or more preferred skills for the mentor, and the fourth dropdown menu 368 may be used to input a preferred division for the mentor. Meanwhile, the text box 370 may be used to input specific mentor selections. For example, the mentee may enter a name (e.g., first and/or last) and/or identification number of the mentor that the mentee would prefer to be matched with. In some example embodiments, entering one or more characters in the text box 370 may trigger an auto-complete and/or auto-suggestion feature, which provides possible one or more matches (e.g., full mentee names and/or identification numbers) based on the characters entered into the text box 370. Inputs received via the user interface 360 may be provided to the registrar 212. Moreover, at least a portion of the information received via the user interface 360 may be stored to the database 120 (e.g., as part of the mentee's profile).

According to some example embodiment, the administrator of the mentoring program may determine the mentor attributes that may be selected via the user interface 360. For instance, the administrator of the mentoring program may determine that a mentee should be able to specify the preferred location, department, skill, and/or division of the mentor the mentee would like to be matched with. As such, the user interface 360 may be populated with visual elements useable by a mentee to select a preferred location, department, skill, and/or division (e.g., the first dropdown menu 362, the second dropdown menu 364, the third dropdown menu 366, the fourth dropdown menu 368). Alternately and/or additionally, the administrator of the mentoring program may further determine the available choices and/or options associated with each preferred mentor attribute. For example, the administrator may specify the cities that may be available as choices and/or options for a mentor's preferred location.

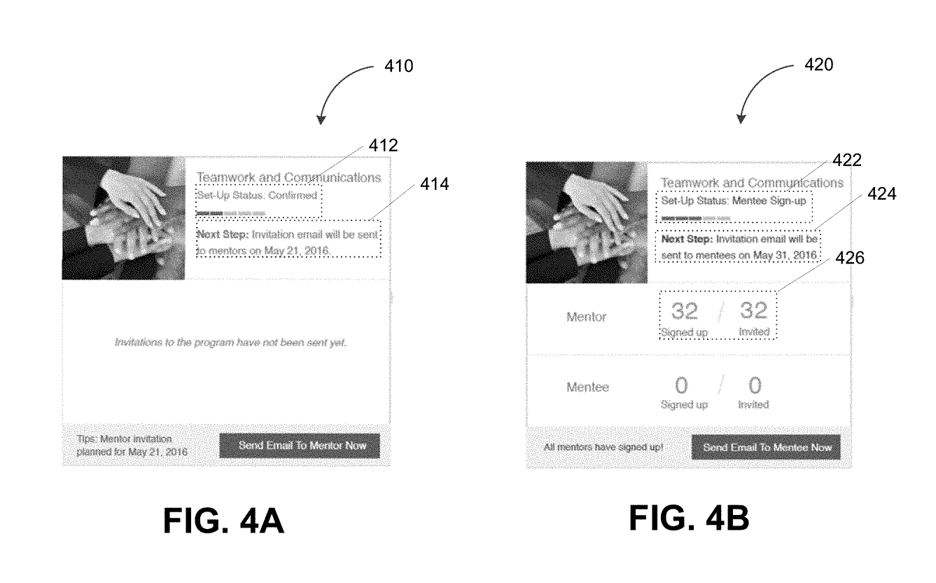

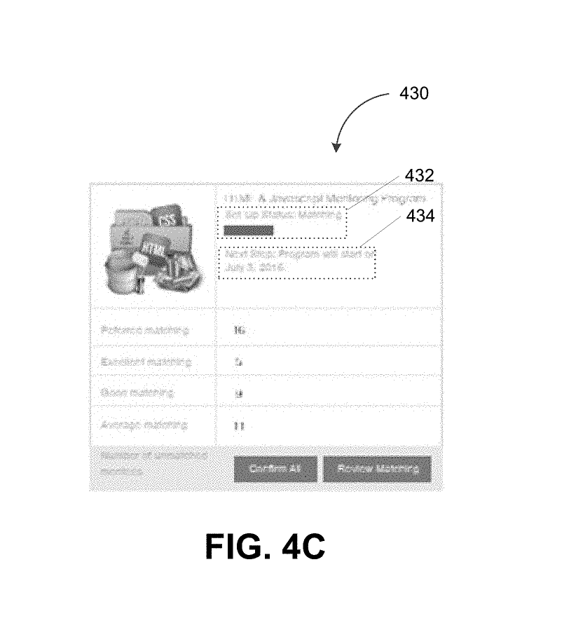

FIGS. 4A-D depicts user interfaces, in accordance with some example embodiments. Referring to FIGS. 1-3 and 4A-D, the controller 110 (e.g., the user interface generator 216) may provide, to an administrator of a mentoring program (e.g., the user of the first user device 132), the user interfaces shown in FIGS. 4A-D in order to provide updates on the progress of the mentoring program. In some example embodiments, the user interfaces shown in FIGS. 4A-D may be different views of a dynamically changing program dashboard adapted to provide an up-to-minute update of the progress of a mentoring program.

FIG. 4A depicts a user interface 410, in accordance with some example embodiments. Referring to FIGS. 1-2 and 4A, the controller 110 (e.g., the user interface generator 216) may provide the user interface 410 to an administrator of a mentoring program when the administrator first sets up and customizes the mentoring program (e.g., via the program customizer 210). As shown in FIG. 4A, the user interface 410 may provide a setup status 412 indicating that the mentoring program is currently active. Furthermore, the user interface 410 may also provide a next step indicator 414 indicating when individuals who have been designated (e.g., via the program customizer 210) as mentors will be notified (e.g., via electronic mail) of the mentoring program.

FIG. 4B depicts a user interface 420, in accordance with some example embodiments. Referring to FIGS. 1-2 and 4B, the controller 110 (e.g., the user interface generator 216) may provide the user interface 420 to an administrator of a mentoring program to indicate a progress of a sign-up and/or registration phase of the mentoring program. For instance, as shown in FIG. 4B, the user interface 420 may display a setup status 422 indicating that the mentoring program is undergoing the sign-up and/or registration phase. The user interface 420 may further display a next step indicator 424 indicating when individuals who have been designated (e.g., via the program customizer 210) as mentees will be notified (e.g., via electronic mail) of the mentoring program. Alternately and/or additionally, the user interface 420 may display a progress metric 426. For example, the progress metric 426 may be number of mentors and/or mentees who have signed up and/or registered for the mentoring program relative to a number of mentors and/or mentees who were invited to sign up and/or register for the mentoring program. However, the user interface 420 may provide additional and/or different progress metrics.

FIG. 4C depicts a user interface 430, in accordance with some example embodiments. Referring to FIGS. 1-2 and 4C, the controller 110 (e.g., the user interface generator 216) may provide the user interface 430 to an administrator of a mentoring program when mentees have been matched with compatible mentors. The user interface 430 may provide a setup status 432 indicating that the mentoring program is in a matching phase. Alternately and/or additionally, the user interface 430 may provide a next step indicator 434 indicating when the mentoring program will commence.

As shown in FIG. 4C, the user interface 430 may further provide a plurality of match metrics including, for example, preferred, excellent, good, and average matches. Moreover, the user interface 430 may provide a corresponding number of matches that satisfy each of the plurality of match metrics. For example, as shown in FIG. 4C, 16 pairs of mentors and mentees are preferred matches. This 16 pairs of mentors and mentees may be preferred matches because these mentors and mentees were matched based on the mentee's specific mentor selection. Alternately and/or additionally, the user interface 430 may also show that 9 pairs of mentors and mentees are good matches. This may be the case for mentors and mentees who were matched based on the individual mentee's preferred mentor attributes.

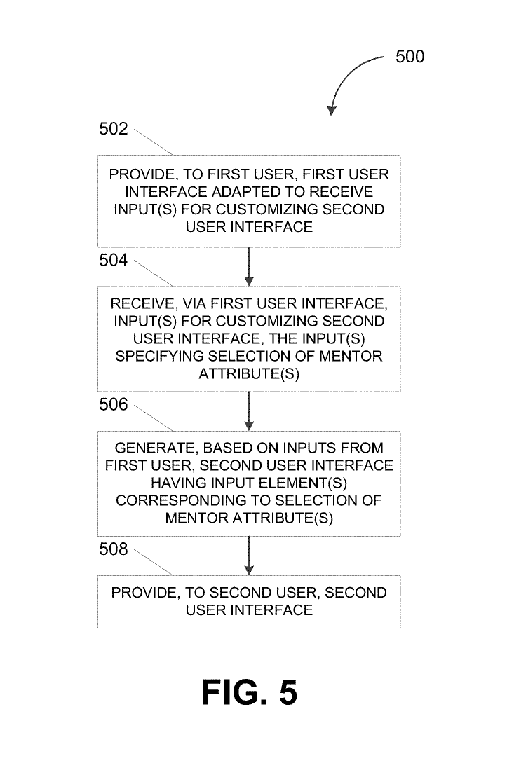

FIG. 5 depicts a flowchart illustrating a process 500 for customizing a mentoring program, in accordance with some example embodiments. Referring to FIGS. 1-5, the process 500 may be performed by the controller 110.

The controller 110 may provide, to a first user, a first user interface adapted to receive one or more inputs for generating a second user interface (502). For example, the controller 110 (e.g., the user interface generator 216) may provide a first user interface (e.g., the user interface 350) that is adapted to receive, from an administrator of a mentoring program, inputs for generating a second user interface (e.g., the user interface 360). Meanwhile, the second user interface may be used by program participants (e.g., mentors and/or mentees) during the sign-up and/or registration phase of the mentoring program. Thus, the second user interface may provide visual elements useable for entering data relevant to the determination of compatible mentors and mentees (e.g., specific mentor selections, preferred mentor attributes).

The controller 110 may receive, via the first user interface, the one or more inputs from the first user for generating the second user interface, the one or more inputs specifying at least one mentor attribute (504). In some example embodiments, the administrator of the mentoring program may specify, via the first user interface, the preferred mentor attributes that mentees are able to stipulate during the sign-up and/or registration phase of the mentoring program. For instance, the administrator of the mentoring program may specify that mentees are able to stipulate including, for example, a preferred location, department, division, gender, and/or skill of the mentor. Moreover, the administrator may further specify, via the first user interface, the available choices and/or options associated with each of the preferred mentor attribute.

The controller 110 may generate, based at least on the one or more inputs for generating the second user interface, the second user interface having one or more visual elements corresponding to the at least one mentor attribute (506). For instance, the controller 110 (e.g., the user interface generator 216) may generate the second user interface in accordance with the administrator's specifications such that the second user interface includes visual elements (e.g., text boxes, dropdown menus, buttons, radio buttons) corresponding to the preferred mentor attributes (e.g., location, department, division, gender, skills, seniority) that may be stipulated by mentees of the mentoring program.

The controller 110 may provide, to a second user, the second user interface (508). For instance, the controller 110 (e.g., the user interface generator 216) may provide the second user interface to one or more individual that have been designated as mentees in the mentoring program. The controller 110 may provide the second user interface during a sign-up and/or registration phase of the mentoring program. Moreover, the registrar 212 may receive the inputs provided via the second user interface while the match engine 214 may use this input to identify compatible mentors and mentees.

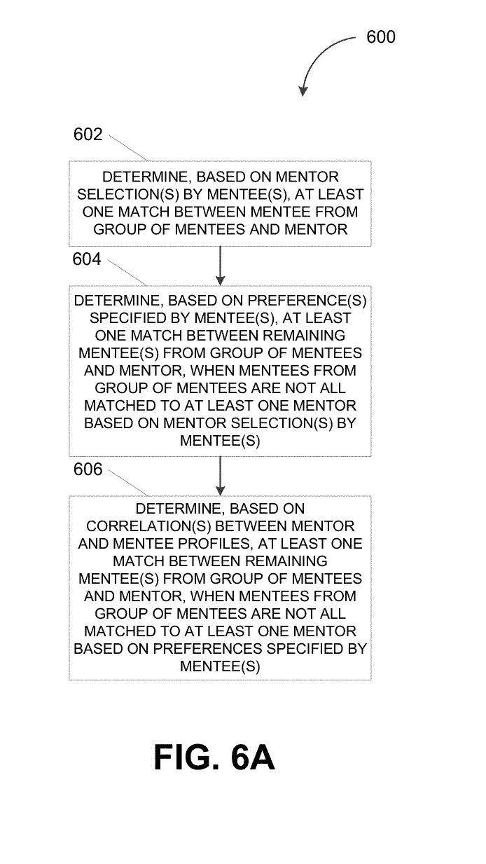

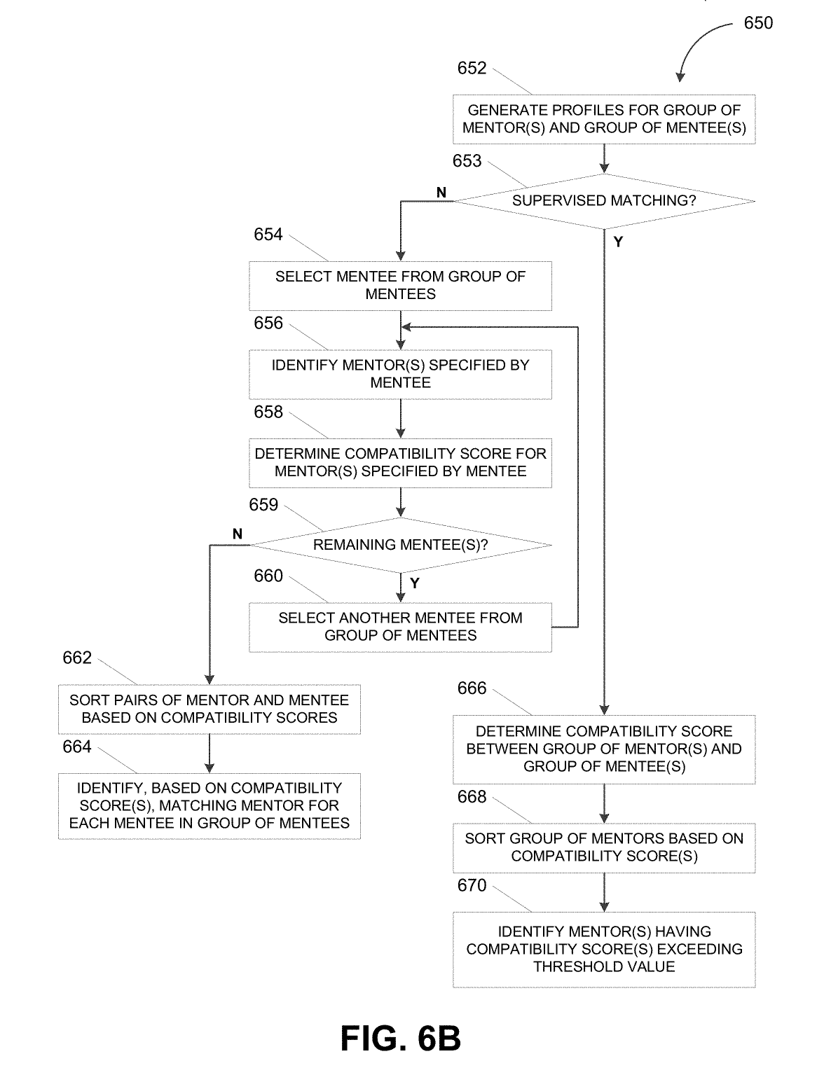

FIG. 6A depicts a flowchart illustrating a process 600 for matching a group of mentees to mentors, in accordance with some example embodiments. Referring to FIGS. 1-6A, the process 600 may be performed by the controller 110.

The controller 110 may determine, based on mentor selections made by one or more mentees, at least one match between a mentee from a group of mentees and a mentor (602). For example, when signing up and/or registering for a mentoring program, one or more mentees may specify specific mentors that the mentees would like to be matched with. As such, the controller 110 (e.g., the match engine 214) may first attempt to identify compatible mentors and mentees based on the specific mentor selections provided by one or more mentees. In some example embodiments, one or more mentees may be prioritized based on when each mentee signed up and/or registered for the mentoring program. As such, mentees who sign up and/or register for the mentoring program earlier may be prioritized over mentees who sign up and/or register for the mentoring program later, when more than a threshold number of mentees all specify the same mentor.

In some example embodiments, a mentee may specify more than one specific mentor that the mentee would like to be matched up with. The mentee may further specify, for each specified mentor, a priority corresponding to a level of preference for being matched with that mentor. In this scenario, the controller 110 may identify a matching mentor for the mentee further based on the priority specified for each specific mentor that the mentee would like to be matched up with. For example, the controller 110 may first attempt to match the mentee to a higher priority mentor. The controller 110 may attempt to match the mentee to a lower priority mentor only when the mentee cannot be matched to a high priority mentor.

Table 1 below shows programming code for a computer-implemented matching protocol where mentees may be matched to mentors based on the mentor selection made by each mentee.

```
TABLE 1
LOOP mentee in group
  DO determine mentor(s) based on selection(s) by mentee
      DO fetch mentor(s) based on selection(s) by mentee
      DO sort selected mentor(s) by compatibility score
      DO put selected mentor(s) into mentor candidate list for mentee
```

When the mentees from the group of mentees are not all matched to at least one mentor based on the mentor selections made by one or more mentees, the controller 110 may determine, based on mentor attributes specified by one or more mentees, at least one match between a remaining mentee from the group of mentees and a mentor (604). For example, the controller 110 (e.g., the match engine 214) may be unable to match every mentee to at least one mentor based on specific mentor selection. As such, the controller 110 may attempt to identify compatible mentors and mentees based on the preferred mentor attributes (e.g., location, department, division, gender, skills, seniority) specified by one or more mentees. In this scenario, the controller 110 may determine a compatibility score for each pair of mentor and mentee. The compatibility score for a pair of mentor and mentee may be determined based on the preferred mentor attributes specified by the mentee. For example, the compatibility score for a pair of mentor and mentee may correspond to a number of the mentee's preferred mentor attributes present in the mentor.

Table 2 below shows programming code for a computer-implemented matching protocol where mentees who cannot be matched based on mentors selections may be matched to mentors based on preferred mentor attributes specified by such mentees.

```
TABLE 2
LOOP mentee in group
  DO determine mentor(s) based on preference(s) specified by mentee
      DO fetch mentee preference(s) data
      LOOP mentor(s) who is(are) not in mentor candidate list for mentee
            IF mentor doesn't exceed maximum of mentee(s) per mentor THEN
                  DO fetch preference(s) data specified by mentor
                  DO  calculate  compatibility  score  based  on  preference(s)
                  specified by mentee and mentor
                  IF compatibility score is more than zero THEN
                        DO put mentor into mentor candidate list for mentee
            ELSE
                  DO go to next mentor who is not in mentor candidate list for
                  mentee
      LOOP mentor(s) who is(are) not in mentor candidate list for mentee
            IF mentor doesn't exceed maximum of mentee(s) per mentor THEN
                  DO fetch mentor profile
                  DO  calculate  compatibility  score  based  on  preference(s)
                  specified by mentee and mentor profile
            ELSE
                  DO go to next mentor who is not in mentor candidate list for
                  mentee
```

When the mentees from the group of mentees are not all matched to at least one mentor based on mentor attributes, the controller 110 may determine, based on correlations between mentor and mentee profiles, at least one match between a remaining mentee from the group of mentees and a mentor (606). For instance, the controller 110 (e.g., the match engine 214) may still be unable to match every mentee to at least one mentor based on preferred mentor attributes (e.g., location, department or division, gender, skills, seniority). Accordingly, the controller 110 may match the remaining mentees to compatible mentors based on correlations between the respective profiles (e.g., employee profiles) of the mentors and mentees.

In some example embodiments, the respective profiles of various mentors and mentees may include data corresponding to a plurality of individual attributes including, for example, gender, department, division, location, job level, job family, job role, job code, and job title. One or more of these individual attributes may further be associated with a weight that corresponds to a relative significance or importance of one individual attribute relative to other individual attributes in determining a match between a pair of mentor and mentee. According to some example embodiments, the controller 110 may determine, for a prospective mentor, a corresponding compatibility score that is a weighted sum of the matching attributes between that prospective mentor and the remaining mentee. The controller 110 may match the remaining mentee to a mentor with whom the remaining mentee is determined to have the highest compatibility score and/or a compatibility score that exceeds a threshold value.

Table 3 below shows programming code for a computer-implemented matching protocol where mentees who cannot be matched based on mentors selections and/or preferred mentor attributes may be matched to mentors based on correlations between the respective profiles of the mentors and mentees. Here, the controller 110 may determine a correlation score indicative of the correlation between a mentor's profile and a mentee's profile. For example, the correlation score between a mentor profile and a mentee profile may correspond to the dot product between the respective vector representation of the mentor profile and the mentee profile. In some example embodiments, the profiles of one or more mentors and/or mentees may be stored at the database 120. As such, the controller 110 may retrieve the respective profiles of mentors and mentees via one or more API calls and/or queries (e.g., SQL statements) to the database 120.

```
TABLE 3
LOOP mentee in group
      DO determine mentor(s) based on correlation(s) between mentee and mentor(s)
      who is(are) not in mentor candidate list for mentee
        DO fetch mentee profile data
        LOOP mentor(s) who is(are) not in mentor candidate list for mentee
              IF mentor doesn't exceed maximum of mentees per mentor THEN
                    DO fetch preference(s) data specified by mentor
                    DO  calculate  correlation  score  based  on  preference(s)  data
                    specified by mentor and mentee profile
                    IF correlation score is more than zero THEN
                          DO put mentor into mentor candidate list for mentee
        LOOP mentor(s) who is(are) not in mentor candidate list for mentee
              IF mentor doesn't exceed maximum of mentees per mentor THEN
                    DO fetch mentor profile
                    DO  calculate  correlation  score  based  on  mentor  and  mentee
                    profile
                    IF correlation score is more than zero THEN
                        DO put mentor into mentor candidate list for mentee
```

FIG. 6B depicts a flowchart 650 illustrating a process for matching a group of mentees and mentors. Referring to FIGS. 1-5 and 6B, the process 650 may be performed by the controller 110.

The controller 110 can generate profiles for a group of one or more mentors and a group of one or more mentees (652). For example, the controller 110 can generate a profile (e.g., employee profiles) for each of a plurality of mentors and mentees. The profile for a mentor and/or mentee may include a plurality of individual attributes including, for example, gender, department, division, location, job level, job family, job role, job code, and job title.

Table 4 below shows programming code that may be executed to cause the generation of one or more mentor and/or mentee profiles.

TABLE 4

```
DO generate profiles for group of mentor(s) and group of mentee(s)
      DO fetch all preference(s) specified by each mentor
      DO fetch all preference(s) specified by each mentee
      DO fetch profile of each mentor
      DO fetch profile of each mentee
```

The controller 110 can determine whether to perform a supervised match (653). In some example embodiments, an administrator of the mentoring program is able to adjust the results of a supervised match. By contrast, the administrator of the mentoring program is unable to adjust the results of an unsupervised match.

If the controller 110 determines that a supervised match is to be performed (653-Y), the controller 110 may select a mentee from the group of mentees (654). The controller 110 may further identify one or more mentors specified by that mentee (656). For example, the mentee may select one or more mentors that the mentee would like to be matched up with. In some example embodiments, the mentee may further indicate, for each specified mentor, a priority corresponding to a level of preference for being match with that mentor.

The controller 110 may determine a compatibility score for the mentee and each of the mentors specified by the mentee (658). In some example embodiments, the controller 110 may determine a compatibility score for a pair of mentor and mentee. The compatibility score for the pair of mentor and mentee may be determined based on the respective profiles of the mentor and mentee and may correspond to an amount of correlation (e.g., matching number and/or percentage of attributes) between the respective profiles of the mentor and mentee. According to some example embodiments, one or more individual attributes in the profiles of the mentor and mentee may be assigned a weight indicative of the significance or importance of matching these individual attributes. Thus, the compatibility score for a pair of mentor and mentee may be a weighted sum of the matching attributes found in the respective profiles of the mentor and the mentee.

The controller 110 may determine whether there are any remaining mentees in the group of mentees (659). If the controller 110 determines that there are remaining mentees in the group of mentees (659-Y), the controller 110 may select another mentee from the group of mentees (660). The process 650 may continue at 656 where the controller 110 identifies one or more mentors that the other mentee would like to be matched up with.

Alternately and/or additionally, the controller 110 may determine that there are no remaining mentees in the group of mentees (659-N). As such, the controller 110 may sort pairings of mentors and mentees based at least on the compatibility scores associated with each pairing (662). The controller 110 may further identify, based on the compatibility scores associated with each pairing of mentor and mentee, a matching mentor for each mentee in the group of mentees (664). For example, the controller 110 may sort pairs of mentors and mentees in accordance to the compatibility score for each pairing of mentor and mentee. In doing so, the controller 110 may be able to identify the most compatible matches between mentors and mentees (e.g., pairs of mentors and mentees having the highest compatibility scores). In some example embodiments, the administrator of the mentoring program may adjust at least some of the matches determined by the controller 110 based on compatibility scores. For instance, the administrator of the mentoring program may reassign one or more mentors to different mentees and/or reassign one or more mentees to different mentors.

Table 5 below shows programming code for a computer-implemented supervised matching protocol where the programmatically generated match results may be adjusted by an administrator of the mentoring program.

```
TABLE 5
IF supervised match THEN
      DO sort mentee in group by sign-up date in descent order
      LOOP mentee in group
            DO determine mentor(s) based on selection(s) by mentee
                  DO fetch mentor(s) based on selection(s) by mentee
                  DO sort selected mentor(s) by compatibility score
                  DO put selected mentor(s) into mentor candidate list for mentee
            DO determine mentor(s) based on preference(s) specified by mentee
                  DO fetch mentee preference(s) data
                  LOOP mentor(s) who is(are) not in mentor candidate list for mentee
                        IF mentor doesn't exceed maximum of mentee(s) per mentor
                        THEN
                              DO fetch preference(s) data specified by mentor
                              DO calculate compatibility score based on preference(s)
                              specified by mentee and mentor
                              IF compatibility score is more than zero THEN
                                    DO put mentor into mentor candidate list for
                                    mentee
                              ELSE
                                    DO go to next mentor who is not in mentor
                                    candidate list for mentee
                  LOOP mentor(s) who is(are) not in mentor candidate list for mentee
                        IF mentor doesn't exceed maximum of mentee(s) per mentor
                        THEN
                              DO fetch mentor profile
                              DO calculate compatibility score based on preference(s)
                              specified by mentee and mentor profile
                        ELSE
                              DO go to next mentor who is not in mentor candidate
                              list for mentee
      DO determine mentor(s) based on correlation(s) between mentee and mentor(s) who
      is(are) not in mentor candidate list for mentee
            DO fetch mentee profile data
            LOOP mentor(s) who is(are) not in mentor candidate list for mentee
                  IF mentor doesn't exceed maximum of mentees per mentor THEN
                        DO fetch preference(s) data specified by mentor
                        DO calculate correlation score based on preference(s) data
                        specified by mentor and mentee profile
                        IF correlation score is more than zero THEN
                              DO put mentor into mentor candidate list for mentee
            LOOP mentor(s) who is(are) not in mentor candidate list for mentee
                  IF mentor doesn't exceed maximum of mentees per mentor THEN
                        DO fetch mentor profile
                        DO calculate correlation score based on mentor and mentee
                        profile
                        IF correlation score is more than zero THEN
                              DO put mentor into mentor candidate list for mentee
      DO sort mentor candidate list for each mentee by compatibility score
      DO identify mentor(s) according to maximum of mentor(s) per mentee
            LOOP mentee in group
                  IF mentee doesn't exceed maximum of mentor(s) per mentee THEN
                        IF mentor candidate list for mentee(s) is not empty THEN
                              DO put first mentor candidate into final matching list
                              DO remove first mentor candidate from mentor
                              candidate list for mentee
            IF all mentee(s) don't(doesn't) exceed maximum of mentor(s) per mentee or
            mentor candidate list for all mentee(s) is not empty THEN
                  DO go to next round mentee loop
            DO generate final matching list
```

In some example embodiments, the controller 110 may determine that a supervised match is not to be performed (653-N). As such, the controller 110 may determine compatibility scores for a pairing of mentors from the group of mentors and mentees from the group of mentees (666). For instance, the compatibility score for a pair of mentor and mentee may be determined based on the respective profiles of the mentor and mentee. This compatibility score may correspond to an amount of correlation (e.g., matching number and/or percentage of attributes) between the respective profiles of the mentor and mentee. According to some example embodiments, one or more individual attributes in the profiles of the mentor and mentee may be assigned a weight indicative of the significance or importance of matching these individual attributes. Thus, the compatibility score for a pair of mentor and mentee may be a weighted sum of the matching attributes found in the respective profiles of the mentor and the mentee.

The controller 110 may sort pairings of mentors and mentees based on the compatibility scores associated with each pairing of mentor and mentee (668). The controller 110 may further identify one or more pairings of mentor and mentee that are associated with compatibility scores exceeding a threshold value (670). For example, the controller 110 may identify matching mentors and mentees by at least identifying pairs of mentors and mentees that are associated with compatibility scores exceeding a threshold value. Thus, a mentor may be matched to a mentee, when an amount of correlation (e.g., matching number and/or percentage of attributes) between the respective profiles of that mentor and mentee exceeds a threshold value.

Alternately and/or additionally, the controller 110 may further sort pairings of mentors and mentees in accordance to the priority each mentee has assigned to the mentors specified by that mentee. For instance, when two or more pairs of mentors and mentees are associated with the same compatibility score, the controller 110 may further sort these pairs of mentors and mentees based on the priority (e.g., preference level) assigned by the mentees to each mentor. Accordingly, a mentor may be matched to a mentee who specified a higher priority (e.g., preference level) for matching to that mentor than another mentee who specified a lower priority (e.g. preference level) for matching to the mentor.

Table 6 below shows programming code for a computer-implemented unsupervised matching protocol where the programmatically generated match results are not subject to subsequent adjustments by an administrator of the mentoring program.

```
TABLE 6
ELSE unsupervised match THEN
      DO determine mentor(s) based on compatibility score for mentor(s) specified by
      driven mentee
            DO determine mentor(s) based on preference(s) specified by mentee
                  DO fetch mentee preference(s) data
                        LOOP mentor(s) who is(are) not in mentor candidate list for
                        mentee
                              IF mentor doesn't exceed maximum of mentee(s) per
                              mentor THEN
                                    DO fetch preference(s) data specified by mentor
                                    DO calculate compatibility score based on
                                    preference(s) specified by mentee and mentor
                                    IF compatibility score is more than zero THEN
                                          DO put mentor into mentor candidate list
                                          for mentee
                                    ELSE
                                          DO go to next mentor who is not in
                                          mentor candidate list for mentee
                        LOOP mentor(s) who is(are) not in mentor candidate list for
                        mentee
                              IF mentor doesn't exceed maximum of mentee(s) per
                              mentor THEN
                                    DO fetch mentor profile
                                    DO calculate compatibility score based on
                                    preference(s) specified by mentee and mentor
                                    profile
                              ELSE
                                    DO go to next mentor who is not in mentor
                                    candidate list for mentee
            DO determine mentor(s) based on correlation(s) between mentee and
            mentor(s) who is(are) not in mentor candidate list for mentee
                  DO fetch mentee profile data
                  LOOP mentor(s) who is(are) not in mentor candidate list for mentee
                        IF mentor doesn't exceed maximum of mentees per mentor
                        THEN
                              DO fetch preference(s) data specified by mentor
                              DO calculate correlation score based on preference(s)
                              data specified by mentor and mentee profile
                              IF correlation score is more than zero THEN
                                    DO put mentor into mentor candidate list for
                                    mentee
                  LOOP mentor(s) who is(are) not in mentor candidate list for mentee
                        IF mentor doesn't exceed maximum of mentees per mentor
                        THEN
                              DO fetch mentor profile
                              DO calculate correlation score based on mentor and
                              mentee profile
                              IF correlation score is more than zero THEN
                                    DO put mentor into mentor candidate list for
                                    mentee
      DO sort candidate list for driven mentee by compatibility score
      DO identify mentor(s) according to driven mentee's threshold
            IF mentor candidate list for driven mentee is not empty THEN
                  DO put mentor(s) from mentor candidate list into final matching list
                  according to maximum of mentees per mentee
            DO generate final matching list
```

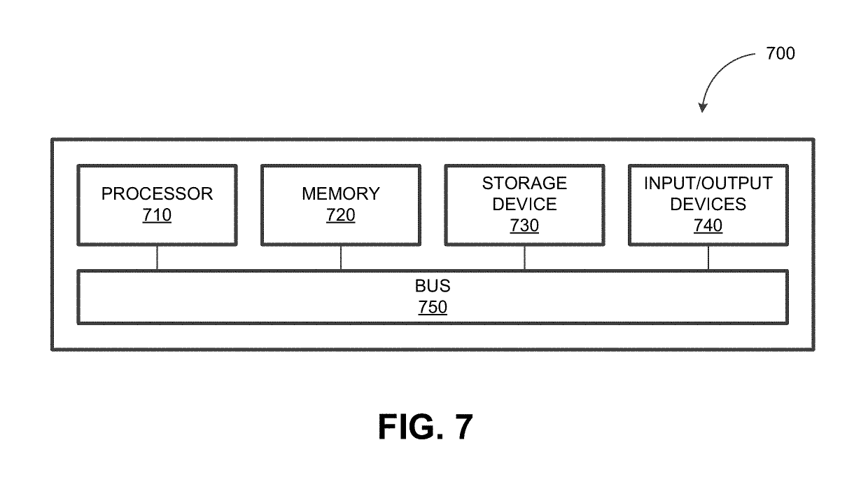

FIG. 7 depicts a block diagram illustrating a computing system 700, in accordance with some example embodiments. Referring to FIGS. 1-7, the computing system 700 can be used to implement the controller 110.

As shown in FIG. 7, the computing system 700 can include a processor 710, a memory 720, a storage device 730, and input/output devices 740. The processor 710, the memory 720, the storage device 730, and the input/output devices 740 can be interconnected via a system bus 750. The processor 710 is capable of processing instructions for execution within the computing system 700. Such executed instructions can implement one or more components of, for example, the controller 110. In some example embodiments, the processor 710 can be a single-threaded processor. Alternately, the processor 710 can be a multi-threaded processor. The processor 710 is capable of processing instructions stored in the memory 720 and/or on the storage device 730 to display graphical information for a user interface provided via the input/output device 740.

The memory 720 is a computer readable medium such as volatile or non-volatile that stores information within the computing system 700. The memory 720 can store data structures representing configuration object databases, for example. The storage device 730 is capable of providing persistent storage for the computing system 700. The storage device 730 can be a floppy disk device, a hard disk device, an optical disk device, or a tape device, or other suitable persistent storage means. The input/output device 740 provides input/output operations for the computing system 700. In some example embodiments, the input/output device 740 includes a keyboard and/or pointing device. In various implementations, the input/output device 740 includes a display unit for displaying graphical user interfaces.

According to some implementations of the current subject matter, the input/output device 740 can provide input/output operations for a network device. For example, the input/output device 740 can include Ethernet ports or other networking ports to communicate with one or more wired and/or wireless networks (e.g., a local area network (LAN), a wide area network (WAN), the Internet).

In some example embodiments, the computing system 700 can be used to execute various interactive computer software applications that can be used for organization, analysis and/or storage of data in various (e.g., tabular) format (e.g., Microsoft Excel®, and/or any other type of software). Alternatively, the computing system 700 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 740. The user interface can be generated and presented to a user by the computing system 700 (e.g., on a computer screen monitor, etc.).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, for example, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
generating, by a controller, a first user interface configured to control selection of a first attribute from a set of attributes;
generating, by the controller, a second user interface generated based on the controlled selection of the first attribute, the second user interface configured to enable a selection of one or more values with respect to the first attribute;
generating, by the controller, a first query to enable querying at the database based on the one or more values with respect to the first attribute;
generating, by the controller, a second query for execution at the database, when the first query fails to receive a response with a match, the second query including a first vector representative of a profile to enable querying the database; and
generating, in response to the first query and/or the second query, a third user interface indicative of a result.

2. The computer-implemented method of claim 1, wherein the profile includes a plurality of attributes associated with a first user, and wherein the first vector includes a numerical representation of at least a portion of the plurality of attributes associated with the first user.

3. The computer-implemented method of claim 1, wherein the second query is executed at the database by at least:
computing a dot product between the first vector and a second vector representative of a reference profile at the database; and
matching the profile to the reference profile, when the dot product exceeds a threshold value.

4. The computer-implemented method of claim 1, wherein second query is executed at the database by at least:
computing a dot product between the first vector and a second vector representative of a first reference profile at the database;
computing another dot product between the first vector and a third vector representative of a second reference profile at the database; and
matching the profile to the first reference profile, when the dot product associated with the first reference profile exceeds the other dot product associated with the second reference profile.

5. The computer-implemented method of claim 1, wherein the result includes the profile being matched to one or more reference profiles at the database.

6. The computer-implemented method of claim 1, wherein the second query includes a hash value corresponding to the first vector.

7. The computer-implemented method of claim 6, wherein the second query is executed at the database by at least:
matching a first reference profile to the profile, when the hash value corresponding to the first vector is the same as a hash value corresponding to a second vector representative of the first reference profile.

8. The computer-implemented method of claim 7, wherein the hash value of the second vector is stored, at the database, in a sorted list of hash values that includes the hash value of the second vector and a hash value of a third vector representative of a second reference profile, and wherein the executing of the second query comprises a lookup of the sorted list hash values.

9. The computer-implemented method of claim 1, wherein the first user interface is generated for presentation at a first device associated with a first user, and wherein the second user interface and/or the third user interface are generated for presentation at a second user device associated with a second user.

10. The computer-implemented method of claim 9, wherein the first user interface is configured to enable the first user to specify one or more input types and/or input values that the second user is able to input, via the second user interface, with respect to the first attribute.

11. A system, comprising:
at least one data processor; and
at least one memory storing instructions which, when executed by the at least one data processor, result in operations comprising:
generating, by a controller, a first user interface configured to control selection of a first attribute from a set of attributes;
generating, by the controller, a second user interface generated based on the controlled selection of the first attribute, the second user interface configured to enable a selection of one or more values with respect to the first attribute;
generating, by the controller, a first query to enable querying at the database based on the one or more values with respect to the first attribute;
generating, by the controller, a second query for execution at the database, when the first query fails to receive a response with a match, the second query including a first vector representative of a profile to enable querying the database; and
generating, in response to the first query and/or the second query, a third user interface indicative of a result.

12. The system of claim 11, wherein the profile includes a plurality of attributes associated with a first user, and wherein the first vector includes a numerical representation of at least a portion of the plurality of attributes associated with the first user.

13. The system of claim 11, wherein the second query is executed at the database by at least:
computing a dot product between the first vector and a second vector representative of a reference profile at the database; and
matching the profile to the reference profile, when the dot product exceeds a threshold value.

14. The system of claim 11, wherein the second query is executed at the database by at least:
computing a dot product between the first vector and a second vector representative of a first reference profile at the database;
computing another dot product between the first vector and a third vector representative of a second reference profile at the database; and
matching the profile to the first reference profile, when the dot product associated with the first reference profile exceeds the other dot product associated with the second reference profile.

15. The system of claim 11, wherein the second query includes a hash value corresponding to the first vector.

16. The system of claim 15, wherein the second query is executed at the database by at least:
matching a first reference profile to the profile, when the hash value corresponding to the first vector is the same as a hash value corresponding to a second vector representative of the first reference profile.

17. The system of claim 16, wherein the hash value of the second vector is stored, at the database, in a sorted list of hash values that includes the hash value of the second vector and a hash value of a third vector representative of a second reference profile, and wherein the executing of the second query comprises a lookup of the sorted list hash values.

18. The system of claim 11, wherein the first user interface is generated for presentation at a first device associated with a first user, and wherein the second user interface and/or the third user interface are generated for presentation at a second user device associated with a second user.

19. The system of claim 18, wherein the first user interface is configured to enable the first user to specify one or more input types and/or input values that the second user is able to input, via the second user interface, with respect to the first attribute.

20. A non-transitory computer-readable storage medium including program code, which when executed by at least one data processor, cause operations comprising:
generating, by a controller, a first user interface configured to control selection of a first attribute from a set of attributes;
generating, by the controller, a second user interface generated based on the controlled selection of the first attribute, the second user interface configured to enable a selection of one or more values with respect to the first attribute;
generating, by the controller, a first query to enable querying at the database based on the one or more values with respect to the first attribute;
generating, by the controller, a second query for execution at the database, when the first query fails to receive a response with a match, the second query including a first vector representative of a profile to enable querying the database; and
generating, in response to the first query and/or the second query, a third user interface indicative of a result.
